(19) United States
(12) Patent Application Publication
(10) Pub. No.: US 2012/0266468 A1
(43) Pub. Date: Oct. 25, 2012

(54) KNIFE BLOCK AND SHARPENER

(75) Inventors: Rosemary Murphy, Kingsgrove (AU); Clive Solari, Paddington (AU)

(73) Assignee: MCPHERSON'S LIMITED, Mulgrave, Victoria (AU)

(21) Appl. No.: 13/501,642

(22) PCT Filed: Oct. 15, 2010
(86) PCT No.: PCT/AU2010/001361

§ 371 Date: Jun. 8, 2012

(30) Foreign Application Priority Data
Oct. 15, 2009 (AU) 2009905038

(51) Int. Cl. B26B 27/00

(52) U.S. Cl. 30/298.4

(57) ABSTRACT

The present invention relates to a device for containing one or more blades. In a preferred for, the device is a knife block for containing a plurality of knives. The device includes a housing having a plurality of openings, each opening for containing a respective blade therein. The device also includes a blade restraining mechanism including a restraining member having active and inactive conditions in that when a blade is inserted within one of the openings such that substantially an entire cutting edge of the blade is within the opening, in the active condition the restraining member prevents withdrawal of the blade from the opening and in the inactive condition the restraining member allows withdrawal of the blade from the opening. In a preferred form, the device is configured to contain a plurality of blades that each include opposite substantially parallel sides which meet at a cutting edge, an opening within the blade extending between and transversely to the substantially parallel sides of the blade and enclosed within the blade, wherein the opening is engaged by the restraining member when in the active position to prevent withdrawal of the blade from the opening and which is disengaged by the restraining member when in the inactive position to allow withdrawal of the blade from the opening. The present invention also relates to a combination of the device and one or more of the blades.

### FIELD OF THE INVENTION

The present invention relates to the field of knife blocks and blade holders. The present invention is described herein with reference to knife blocks and blade holders incorporating means for receiving and holding a plurality of blades such as knife blades. However, it is to be appreciated that the invention may have broader application in relation to holding one or more articles having a sharp blade such as scissors, chisels and the like.

### BACKGROUND OF THE INVENTION

A convenient and common way to store a knife when not in use is to store them in a knife block. Knife blocks typically include a housing or block often made of wood, plastic or metal and including a plurality of openings each configured to receive a blade of a knife therein. When the blade of each knife is received within a respective opening a handle connected to the blade typically protrudes from the opening. When a user wishes to use one of the knives contained within the knife block the user simply grasps the handle associated with the knife and withdraws the knife blade from the opening within the knife block.

A problem with existing knife blocks is that the blades of knives stored in them are only loosely contained in an opening within the knife block. The knife is merely retained in the opening within the knife block, which is typically oriented upwardly, via the force of gravity acting on the knife. Accordingly, if the knife block is tilted or turned upside down there is nothing stopping knives contained within the knife block from falling out of their respective opening. As can be appreciated, if a child or adult overturns a knife block either deliberately or inadvertently one or more knives can fall out of their respective opening within the knife block and injure that person.

Accordingly, a need exists for a knife block or a block holder for containing and storing one or more blades such as knife blades when not in use and that alleviates the problem of one or more of those blades inadvertently falling out of a respective opening within the knife block or blade holder as a result of tilting or overturning the knife block or blade holder.

### SUMMARY OF THE INVENTION

Accordingly, the present invention provides, in one aspect, a device for containing one or more blades, the device including:

a housing having a plurality of openings, each opening for containing a respective blade therein;

a blade restraining mechanism including a restraining member having active and inactive conditions in that when a blade is inserted within one of the openings such that substantially an entire cutting edge of the blade is within the opening, in the active condition the restraining member prevents withdrawal of the blade from the opening and in the inactive condition the restraining member allows withdrawal of the blade from the opening.

In one form, the blade restraining mechanism includes one or more restraining members, wherein each restraining member is associated with one or more of the openings.

In one form, the blade restraining mechanism includes a blade release mechanism that is operable for causing the one or more restraining members to change from the active condition to the inactive condition.

In another form, the blade release mechanism is operable for causing each of the one or more restraining members to change from the active condition to the inactive condition.

In another form, the blade release mechanism includes a manual release mechanism including at least two stages of movement.

In one form, a first one of the stages involves manually moving a manually operable release member in a first direction and the second stage involves manually moving the manually operable release member in a second direction.

In one form, the first direction is transverse to the second direction.

In one form, the first direction of movement involves linear translation of the manually operable release member along an axis and the second direction of movement involves rotation of the manually operable release member about the axis.

In another form, the blade release mechanism includes a third stage of movement.

In one form, the third stage includes rotation of the manually operable release member about the axis.

In one form, the blade restraining mechanism includes one restraining member in the form of an elongated blade engaging member that is positionable adjacent the openings and extending substantially perpendicular to opposite parallel sides of the blade when the blade is inserted within the opening, the elongated blade engaging member being movable between a position in which when substantially the entire cutting edge of the blade is within the opening the elongated blade engaging member engages the blade and prevents withdrawal of the blade and a position in which when substantially the entire cutting edge of the blade is within the opening the elongated blade engaging member is out of engagement with the blade and allows withdrawal of the blade.

In another form, the elongated blade engaging member includes a rod that is receivable within an opening within the blade extending between and transversely to the opposite parallel sides of the blade.

In one form, the housing includes an aperture that is aligned with the direction opening within the blade when the blade is inserted within the opening, the aperture receives the rod therethrough when the blade restraining member is in the active condition.

In one form, the manually operable release member is a substantially planar panel member and wherein the first stage involves manually moving the manually operable release member in a direction substantially parallel to the plane of the panel and the second stage involves manually moving the manually operable release member in a direction transverse to the plane of the panel.

In one form, each restraining member includes an arm positioned within the opening and extending substantially parallel to opposite parallel sides of the blade when the blade is inserted within the opening, one end of the arm having a blade engaging portion and another end of the arm being pivotally attached to the housing to enable the blade engaging portion and the arm to pivot in an arc between a position in which when substantially the entire cutting edge of the blade is within the opening the blade engaging portion engages the blade and prevents withdrawal of the blade and a position in which when substantially the entire cutting edge of the blade is within the opening the blade engaging portion is out of engagement with the blade and allows withdrawal of the blade.

In another form, the blade engaging portion includes a projection extending in a direction transverse to the opposite parallel sides of the blade and configured to be received within an opening within the blade extending between and transversely to the opposite parallel sides of the blade.

In one form, the restraining member is biased towards an active position in which the restraining member is in the active condition and is configured so that insertion of the blade within the opening actuates the restraining member to an inactive position in which the restraining member is in the inactive condition until when substantially the entire cutting edge of the blade is inserted within the openings the restraining member is biased to the active position.

In one form, the device is a knife block.

In another form, the device further includes a blade sharpener for sharpening the cutting edge of the blade.

In another aspect, the invention provides in combination a blade and a device for containing one or more of the blades including the device of any of the forms of the device of the aspect of the invention set out above.

In one form, the blade includes opposite substantially parallel sides which meet at a cutting edge, and opening within the blade extending between and transversely to the substantially parallel sides of the blade and enclosed within th blade, wherein the opening is engaged by the restraining member when in the active condition to prevent withdrawal of the blade from the opening and which is disengaged by the restraining member when in the inactive condition to allow withdrawal of the blade from the opening.

In another aspect, the invention provides a blade configured for use with the device for containing one or more blades according to any of the forms of the device of the aspect of the invention set out above, the blade including a handle and opposite substantially parallel sides extending from the handle which meet at a cutting edge, an opening within the blade extending transversely to the parallel sides and positioned adjacent to the handle and an end of the cutting edge adjacent to the handle.

Further aspects and concepts will become apparent to those skilled in the art after considering the following description and claims in conjunction with the accompanying drawings.

### BRIEF DESCRIPTION OF THE DRAWINGS

In the accompanying drawings, which are incorporated in and constitute a part of the specification, embodiments of the invention are illustrated which together with a general description of the invention given above, and the detailed description below, serve to exemplify embodiments of the invention.

FIG. 1 is a perspective view of a knife block in accordance with an embodiment of the invention including a plurality of openings for respectively containing a blade of a knife therein when the knife is not in use and a blade sharpening device for sharpening the cutting edge of the blades.

FIG. 2 is a front view of a cross section of the knife block and knives of FIG. 1.

FIG. 3 is a plan view of the knife block and knives of FIG. 1.

FIG. 4 is a partially exploded view of the knife block of FIG. 1 and the components thereof.

FIG. 5 is an exploded view of components of a blade restraining mechanism of the knife block of FIG. 1 the restraining mechanism including a plurality of blade restraining members each associated with an opening for receiving a blade and a blade release mechanism.

FIG. 6 is a partially cut away view of the blade restraining mechanism of the knife block of FIG. 1 showing the means by which the restraining mechanism is operable for restraining a plurality of knife blades within a respective one of the openings of the knife block wherein the restraining mechanism includes a plurality of restraining members each in an active position operable for preventing withdrawal of the blades from within respective openings of the knife block.

FIG. 7 is a partially cut away view of the restraining mechanism of the knife block of FIG. 1 in which the restraining members are in an inactive position due to the operation of the blade release mechanism for allowing withdrawal of the blades from within respective openings within the knife block.

FIG. 8 illustrates a partially cut away view of the restraining mechanism of the knife block of FIG. 1 in which the restraining members are in the inactive position due to the operation of a guide member associated with each restraining member prior to complete insertion of a blade within a respective one of the openings within the knife block.

FIG. 9 illustrates a partially cut away view of the restraining mechanism of the knife block of FIG. 1 showing abutment elements configured for abutting against respective restraining members to facilitate movement of the restraining members from the active position to the inactive position in response to operation of the blade release mechanism.

FIG. 10 is a front perspective view of a knife block in accordance with another embodiment of the invention including a plurality of openings for respectively containing a blade of a knife therein when the knife is not in use and a blade sharpening device for sharpening the cutting edge of the blades.

FIG. 11 is a partially cut away view of the blade restraining mechanism of the knife block of FIG. 10 showing the means by which the restraining mechanism is operable for restraining a plurality of knife blades within a respective one of the openings of the knife block wherein the restraining mechanism includes a restraining member in an active position operable for preventing withdrawal of the blades from within respective openings of the knife block.

FIG. 12 is a perspective view of the blade restraining mechanism of the knife block of FIG. 10.

FIG. 13 is a side view of a section of the blade restraining mechanism of the knife block of FIG. 10.

FIG. 14 is a side view of a section of a portion of the blade restraining mechanism of the knife block of FIG. 10 illustrating, in more detail, components of a blade release mechanism of the restraining mechanism wherein the release mechanism has partially moved through one direction of motion.

FIG. 15 is a side view of a section of a portion of the blade restraining mechanism of the knife block of FIG. 10 illustrating, in more detail, components of a blade release mechanism of the restraining mechanism wherein the release mechanism has fully moved through one direction of motion.

FIG. 16 is an exploded view, from one perspective, of components of a blade restraining mechanism of the knife block of FIG. 10.

FIG. 17 is an exploded view, from another perspective, of components of a blade restraining mechanism of the knife block of FIG. 10.

FIG. 18 is a reverse perspective view of a knife block in accordance with the embodiment illustrated in FIG. 10.

### DETAILED DESCRIPTION

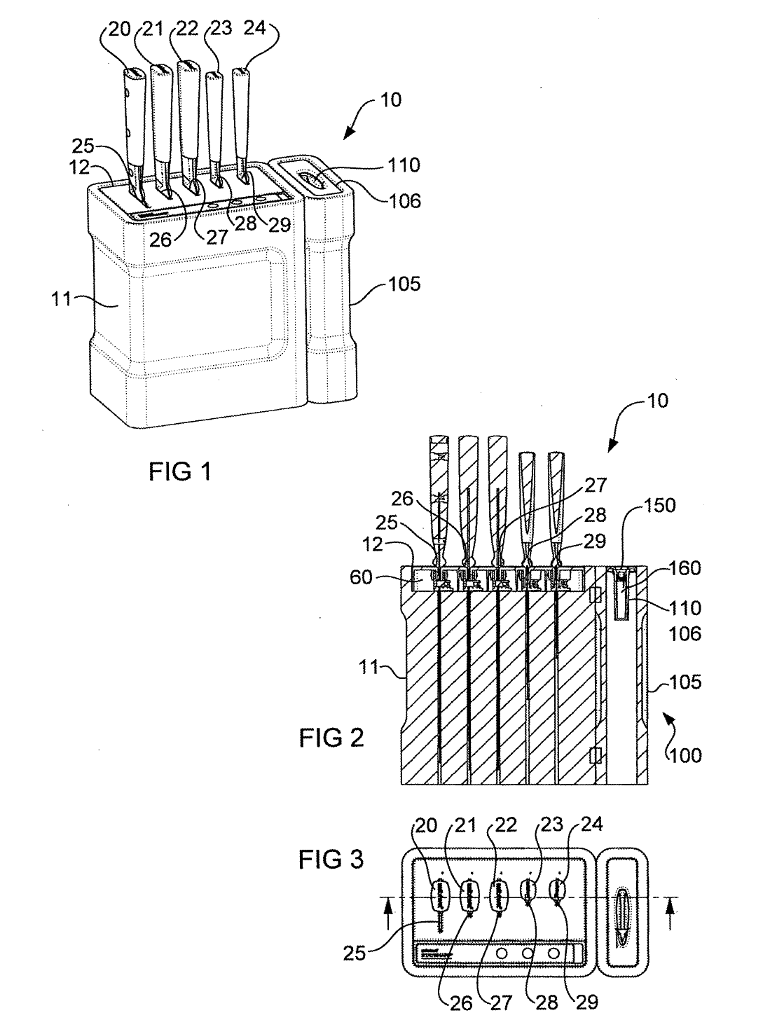

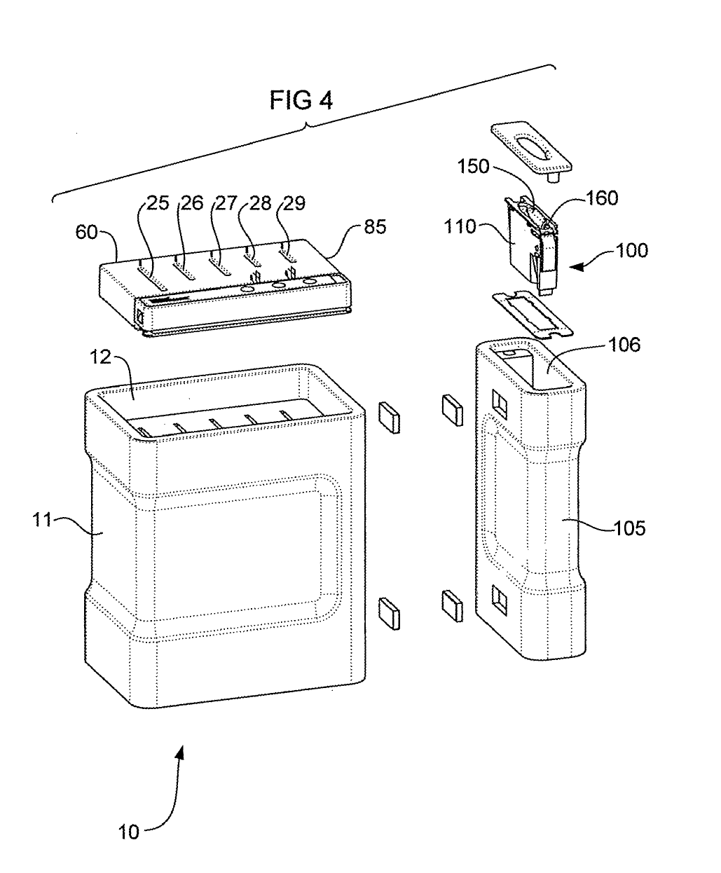

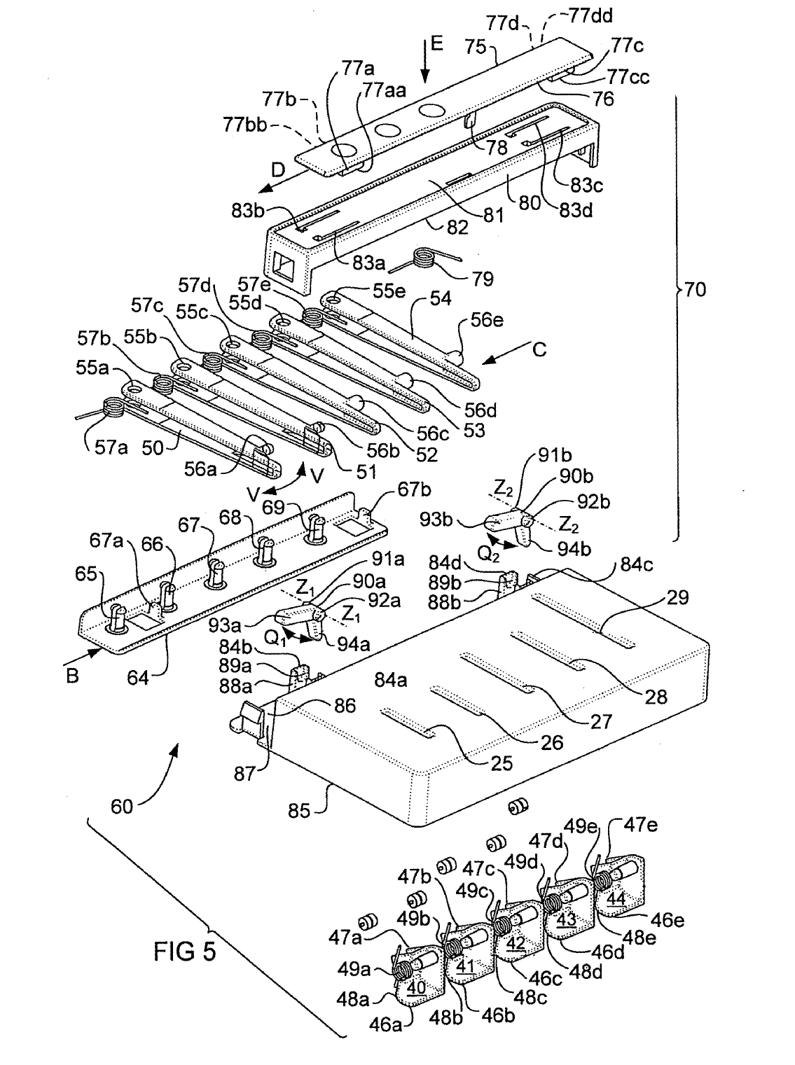

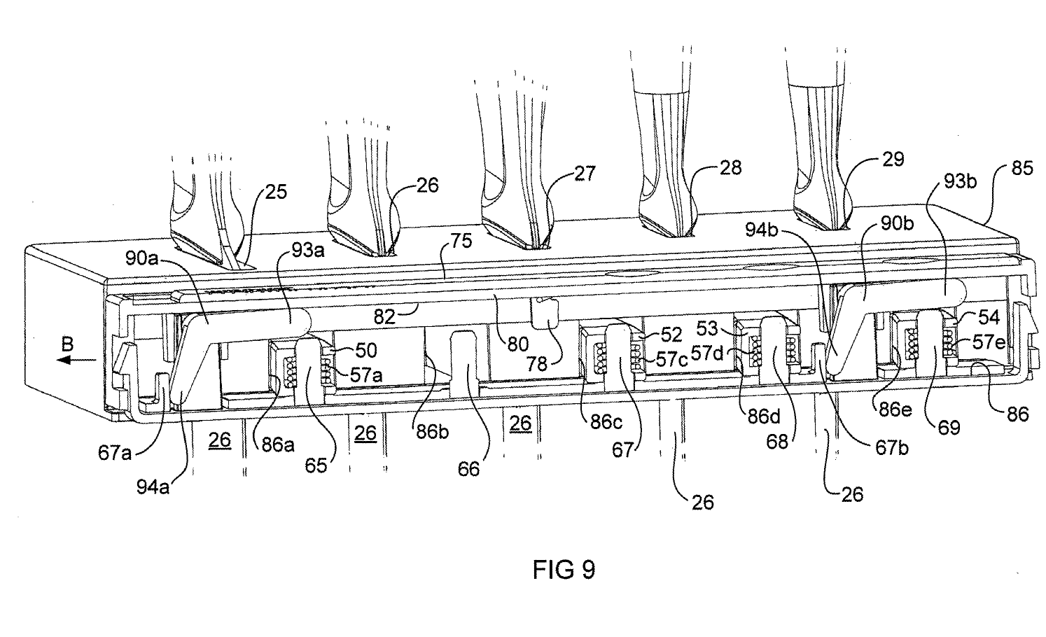

Referring to FIGS. 1 to 9, there is shown a device in accordance with an embodiment of the invention, in the form of a knife block 10, which is configured to store a plurality of knives 20, 21, 22, 23, 24 therein. Alternatively, the device may be a blade holder for storing a plurality of blades such as scissor blades, chisel blades or any other article including a blade or some other dangerous or hazardous component. The knife block 10 embodiment includes a housing 11 having a plurality of openings 25, 26, 27, 28, 29 each in the form of a longitudinal slot for receiving a respective one of the knives 20-24 therein.

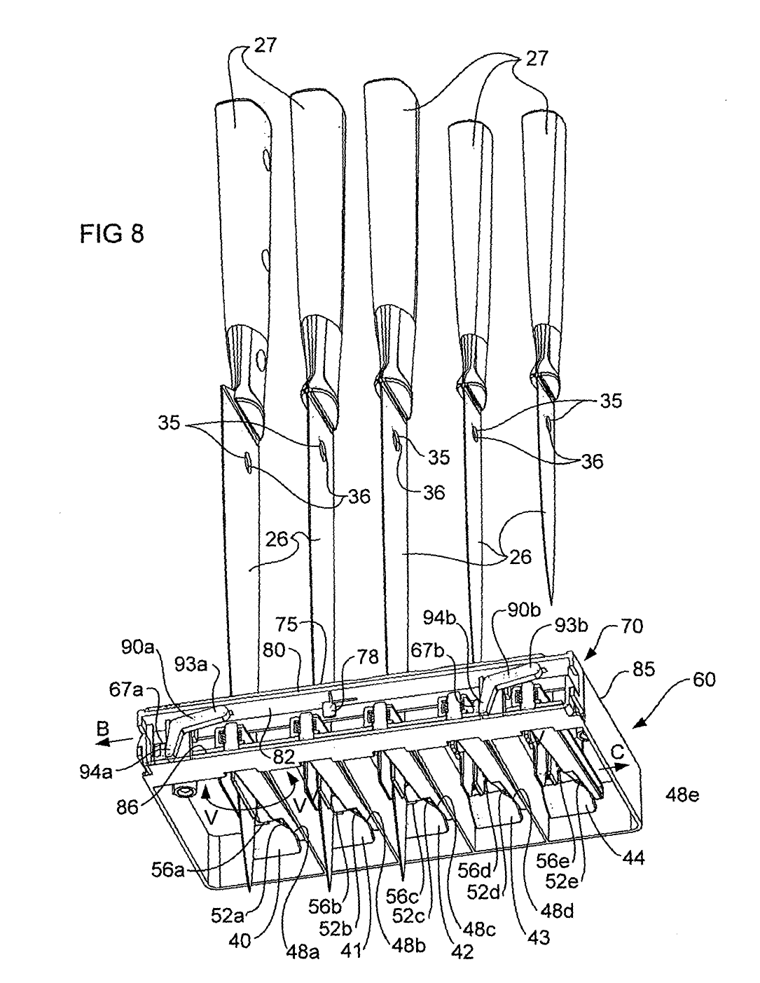

As can best be seen in FIG. 8 each one of the knives 21-25 includes a blade 26 and a handle 27. The blade 26 includes a pair of elongated parallel sides 30, 31, a blunt edge 32 and a cutting edge 33 opposite the blunt edge 32. The blade 26 is connected to the handle 27 by a tang 28. The tang 28 is an integral extension of the blade 26. The blunt edge 32 and the cutting edge 33 extend substantially the length of the blade 26 from the tang 28 and the handle 27 to a pointed tip 34. The blade 26 includes an opening 35 between the parallel sides 30, 31 of the blade 26 for the reasons set out below. The opening 35 is an enclosed opening and extends through the blade 26 between the parallel sides 30, 31 in a direction substantially transverse to the parallel sides 30, 31. Thus, the opening 35 has a central longitudinal axis A-A which runs in a direction substantially transverse to the parallel sides 30, 31 of the blade 26. Because the opening 35 is within the blade 26 the opening 35 is enclosed such that the opening 35 is completely surrounded in a plane transverse to the longitudinal axis A-A of the opening 35 by a surface 36 surrounding the opening 35 which is integral with the rest of the blade 26.

As shown in FIGS. 1-8, and particularly FIG. 5, the knife block 10 includes a blade restraining mechanism 60 which includes a plurality of restraining members 50, 51, 52, 53, 54. Each one of the restraining members 50-54 is associated with a respective one of the openings 25-29 of the knife block 10. Each one of the restraining members 50-54 is an elongated arm including a respective one of a set of openings 55a, 55b, 55c, 55d, 55e at one end for receiving a respective one of a set of protrusions 65, 66, 67, 68, 69 associated with a sliding pivot member 64. Each of the restraining members 50-54 pivots about one of the protrusions 66-69 in an arc range of motion in a plane that is transverse and, optionally substantially perpendicular to, the parallel sides 30, 31 of the blade 26 when inserted within a respective one of the openings 25 to 29. The arc through which the restraining members 50-54 pivot is represented by the arrow V

Each one of a set of restraining member biasing members 57a, 57b, 57c, 57d, 57e, which is optionally in the form of a torsion spring but may include any suitable biasing device, is mounted relative to the sliding pivot member 64 and a respective one of each of the restraining members 50-54 so as to bias each of the restraining members 50-54 in one direction through the arc range of motion V of each of the restraining members 50 to 54 about a respective one of the protrusions 65-69. Each of the restraining members 50-54 includes a respective one of a set of blade opening engaging portions 56a, 56b, 56c, 56d, 56e which, in the embodiments illustrated in the figures, are each in the form of a protrusion extending laterally from a respective one of each of the restraining members 50-54 in a plane that is transverse to the elongated parallel sides 30, 31 of the blade 26 when inserted within a respective one of the openings 25-29. The blade opening engaging portion 56a-56e also extends substantially in the direction of the arc range of motion V in which the restraining member 50-54 is biased. Each of the restraining members 50-54 is arranged to extend in a direction substantially parallel to the longitudinal direction of the slot shaped openings 25-29 within the knife block 10. Accordingly, each of the restraining members 50-54 extends in a direction substantially parallel to the parallel sides 30-31 of the blade 26 upon insertion within a respective one of the openings 25-29.

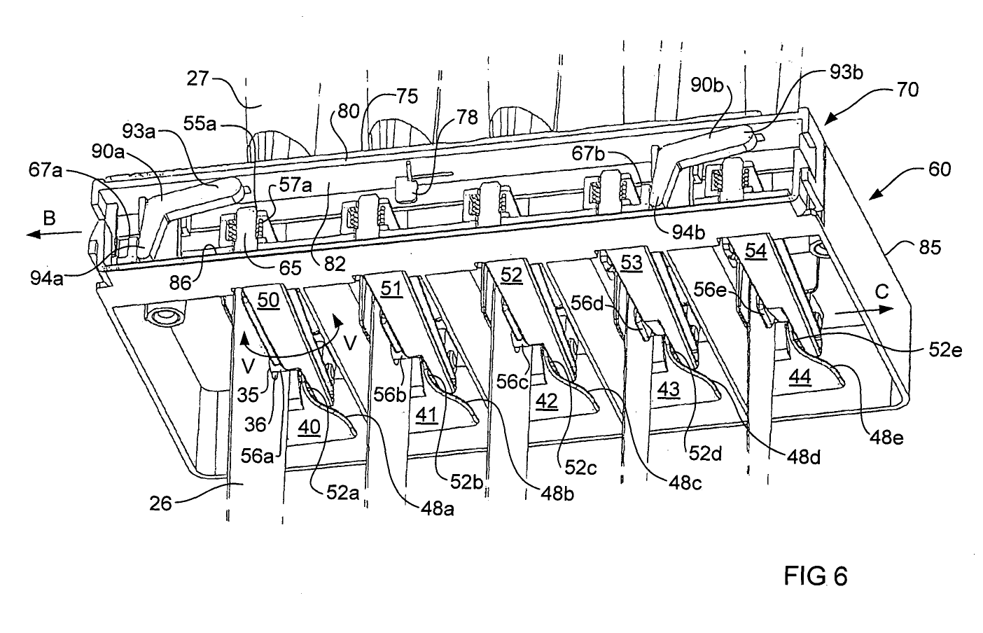

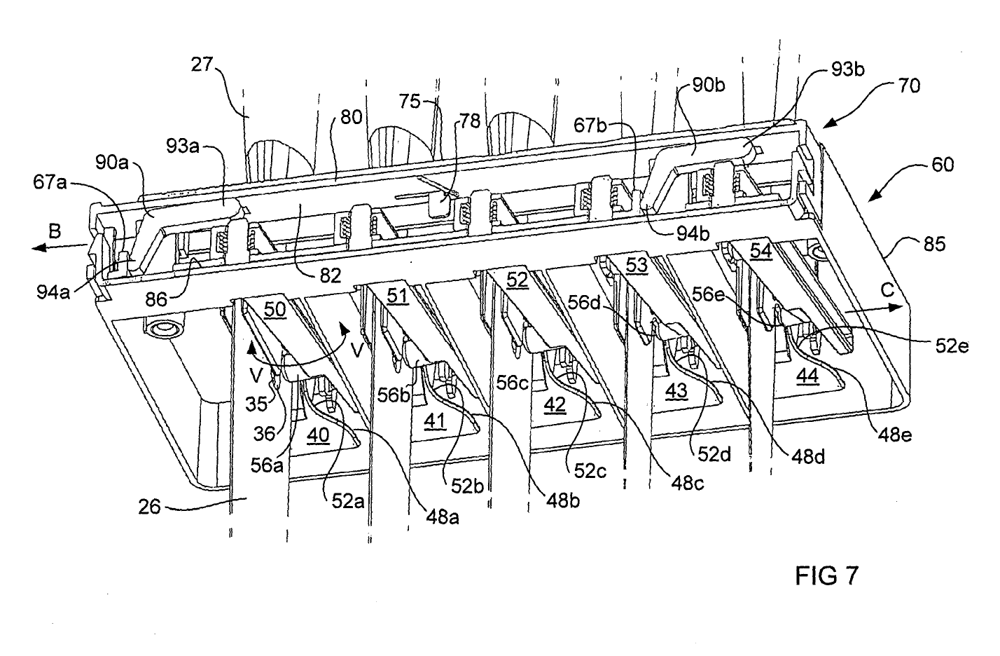

As shown in FIG. 6, the arrangement of the restraining members 50-54, the sliding pivot member 64 and the biasing members 57a-57e cause the engaging portions 56a-56e of each of the restraining members 50-54 to be biased into a respective opening 35 within a respective blade 26 when substantially the entire cutting edge 33 of the blade 26 is inserted within a respective one of the openings 25-29. Accordingly, the condition of each of the restraining members 50-54 in which their respective engaging portion 56a-56e is received within an opening 35 of a blade 26, as shown in FIG. 6, is an active condition in which the restraining members 50-54 are operable for preventing inadvertent withdrawal of a respective blade 26 from within a respective one of the openings 25-29. The active condition of the restraining members 50-54 is a position of the restraining members 50-54 in which when a respective blade 26 is inserted within a respective opening a respective one of the restraining members 50-54 is operable for preventing withdrawal of the blade 26. Thus, the term active position corresponds to active condition in the embodiment described herein. When the restraining members 50-54 are in the active position the opening 35 within the blade 26 receives a respective one of the engaging portions 56a-56e such that the engagement portion 56a-56e engages and abuts with the surface 36 surrounding the opening 35 within the blade 26 thereby preventing withdrawal of the blade 26 from within the respective one of the openings 25-29 of the knife block 10. Each one of the restraining members 50-54 can pivot in its respective arc range of motion V from the active position described above, to an inactive position shown in FIGS. 7 and 8 in which the engaging portion 56a-56e of each of the restraining members 50-54 is outside the opening 35 of the blade 26 when substantially the entire cutting edge 33 of the blade 26 is received within the opening 25-29 of the knife block 10 or if substantially the entire cutting edge 33 of the blade 26 were to be received within the opening 25-29 of the knife block 10. In the inactive position as shown in FIG. 7, when the substantially entire cutting edge of the blade is received within the opening 25-29 the engaging portion 56a-56e no longer engages and abuts with the surface 36 surrounding the opening 35 within the blade 26. Also, in the inactive position, as shown in FIG. 8 the engaging portions 56a-56e do not obstruct the insertion of the blade 26 within a respective one of the openings 25-29. The inactive position of the restraining members 50-54 corresponds to an inactive condition of the restraining members 50-54. In the inactive condition the restraining members 50-54 do not prevent withdrawal of the blade 26 from a respective one of the openings 25-29 and do not obstruct or impede insertion of the blade 26 into a respective one of the openings 25-29.

Although in the embodiments illustrated herein the active and inactive conditions of the restraining members 50-54 respectively involve active and inactive positions of the restraining members 50-54 physically displaced from and distinct from one another. It is conceivable that the active and inactive conditions of the restraining members 50-54 are not achieved by physical movement threat but by some other means. For example, one or many of the restraining members 50-54 may have no moving parts.

As shown in FIG. 6, each of the restraining members 50-54 is biased towards the active position by a respective one of the biasing members 57a-57e. To cause the restraining members 50-54 to be moved to the inactive position shown in FIGS. 7 and 8 the restraining members 50-54 must be actuated against the biasing force applied by the biasing members 57a-57e thereto in a manner described below.

Arranged within each one of the openings 25-29 of the knife block 10 is a respective blade guide 40, 41, 42, 43, 44. Each one of the blade guides 40-44 includes a pivoting blade guide member 46a-46e including a respective blade receiving groove 47a-47e and a curved restraining member engaging surface 48a-48e. The restraining member engaging surface 48a-48e is a generally curved surface on a lateral portion of the pivoting blade guide member 46a-46e adjacent the blade receiving groove 47a-47e. The restraining member engaging surface 48 acts like a cam and the restraining members 50-54 act like followers as will be described below. The pivoting blade guide member 46a-46e is pivotally mounted within and adjacent to a respective one of the openings 25-29 of the knife block 10. A biasing member 49a-49e, which in the embodiments illustrated is a torsion spring but could be any suitable biasing member, associated with each blade guide 40-44 is arranged to bias the pivoting blade guide member 46a-46e to a position as shown in FIG. 8 in which a highest portion 51a, 51b, 51c, 51d, 51e of the curved restraining member engaging surface 48a-48e engages and actuates the restraining member 50-54 to its maximum displacement in the arc V from the active position. The position of each of the restraining members 50-54 maximally displaced from the active position by the blade guide members 46a-46e is the inactive position in which insertion of the blade 26 into a respective one of the openings 25-29 is not obstructed by the engaging portions 56a-56e of the restraining members 50-54.

As the blade 26 is inserted within a respective one of the openings 25-29 as shown in FIG. 8 the blunt edge 32 of the blade 26 is received within and engages the blade receiving groove 47a-47e of a respective one of the guide members 46a-46e. Continued insertion of the blade 26 causes the guide member 46a-46e to pivot against the action of the biasing member 49a-49e to a position shown in FIG. 6 in which a lowest portion 52a, 52b, 52c, 52d, 52e of the curved engaging surface 48a-48e engages the restraining member 50-54. When the lowest portion 52a-52e of the curved engaging surface 48a-48e engages the restraining member 50-54 the restraining member engaging surface 48a-48e allows the restraining member 50-54 to be biased by the biasing member 57a-57e from the inactive position shown in FIG. 8 to the active position shown in FIG. 6. Thus, as the blade 26 is inserted within a respective one of the openings 25-29 such that substantially the entire cutting edge 33 of the blade 26 is received within the opening 25-29 the restraining member 50-54 is biased to the active position in which the engaging portion 56 is received within the opening 35 of the blade 26 to thereby restrain the blade 26 from inadvertent withdrawal from the opening 25-29 of the knife block 10.

The operation of the blade release mechanism 70 will now be described with particular reference to FIGS. 5 to 9. The blade release mechanism 70 includes a manually operable unlocking member 75 and a manually operable release member 80. The unlocking member 75 and the release member 80 are mounted to a frame 85. The frame 85 is mounted within an open end 12 of the housing 11 of the knife block 10. The frame 85 contains the openings 25-29 of the knife block 10 each for receiving the blade 26 of one of the knives 20-24. The frame 85 further includes a mounting portion 87 positioned adjacent to the openings 25-29. The unlocking member 75 and the release member 80 are mounted to the mounting portion 87 in a manner described below.

The mounting portion 87 of the frame 85 includes a mounting panel 86 and a pair of mounting projections 88a, 88b upstanding from the mounting panel 86. Each of the upstanding mounting projections 88a, 88b is internally hollow and has an upwardly facing opening 89a, 89b for receiving a respective one of a pair of lever members 90a, 90b therein. The lever member 90a, 90b is a substantially L-shaped member having a pair of pivotal mounting portions 91a, 92a, 91b, 92b extending laterally therefrom. The pivotal mounting projections 91 a, 92a, 91 b, 92b of each lever member 90a, 90b extends in a respective axis Z₁-Z₁, Z₂-Z₂ and are arranged to be received by a cradle formed within the opening 89a, of the upstanding mounting projections 88a, 88b so as to enable the lever members 90a, 90b to pivot about their respective axis Z₁-Z₁, Z₂-Z₂.

Each of the lever members 90a, 90b includes a first arm 93a, 93b and a second arm 94a, 94b. The first arm 93a, 93b and the second arm 94a, 94b are integrally attached to each other and extend at a substantially obtuse angle relative to each other. The projections 91a, 92a, 91b, 92b extend from the lever member 90a, 90b substantially transversely to the first and second arms 93a, 94b, 93b, 94b in the direction of the axes Z₁-Z₁, Z₂-Z₂. The projections 91a, 92a, 91b, 92b are configured to be received within the cradle within the opening 89a, 89b of a respective one of the upstanding mounting projections 89a, 89b such that the first and second arms 93a, 94a, 93b, 94b pivot about the axis Z₁-Z₁, Z₂-Z₂. The first arm 93a, 93b of the lever member 90a, 90b is configured to abut against a lower surface 82 of the release member 80 whereas the second arm 94 is arranged to abut against an abutment member 67a, 67b attached to the sliding pivot member 64. The arrangement is such that when a user depresses the release member 80 in a downward direction represented by the arrow E towards the lever members 90a, 90b the lower surface 82 of the release member 80 pushes the first arm 93a, 93b of each of the lever members 90a, 90b downwardly towards the sliding pivot member 64. When the first arm 93a, 93b is pushed downwardly the second arm 94a, 94b of each lever member 90a, 90b is caused to pivot in a respective arc range of motion indicated by the arrows Q₁, Q₂ about the axis Z₁-Z₁, Z₂-Z₂ in a plane aligned with the downward direction of motion of the release member 80 shown by the arrow E. The pivoting second arms 94a, 94b thereby engage the abutment member 67a of the sliding pivot member 64 to thereby move the sliding pivot member 64 in a lateral direction substantially perpendicular to the direction E of downward depression of the release member 80.

The direction of movement of the sliding pivot member 64 in response to depression of the release member 80 is represented in FIGS. 5 to 9 by the arrow B. The sliding motion of the pivot member 64 is such that each of the protrusions 66a-66e extending therefrom and the end of each of the restraining members 50-54 having the openings 55a-55e pivotally connected to the protrusions 66a-66e also move in the same lateral direction B as the sliding pivot member 64. As a result of movement of the end of each of the restraining members 50-54 incorporating the opening 55a-55e in the direction of the arrow B each of the restraining members 50-54 abuts at a point between the end incorporating the opening 55a-55e and the end incorporating the engaging portion 56a-56e against a respective abutment element 86a, 86b, 86c, 86d, 86e associated with the frame 85. As a result of movement of the sliding pivot member 64 in the direction of the arrow B the restraining members 50-54 pivot about their respective points of contact with the abutment elements 86a-86e. Thus, the ends of the restraining members 50-54 including the engaging portions 56a-56e move in a direction indicated by the arrow C which is the opposite direction to the direction of movement of the sliding pivot member 64 indicated by the arrow B. Movement of the engaging portions 56a-56e of the restraining members 50-54 in the direction of the arrow C, when substantially the entire cutting edge 33 of the blade 26 is within a respective one of the openings 25-29, results in the restraining members 50-54 and the projections forming the engaging portions 56a-56e to move from the active position in which the engaging portions 56a-56e are positioned within a respective one of the openings 35 of the blades 26 to the inactive position outside of the respective opening 35 of the blades 26. Thus, movement of the engaging portions 56a-56e of the restraining members 50-54 in the direction of the arrow C enables the blade 26 to be withdrawn from within a respective one of the openings 25-29 of the knife block 10.

The blade release mechanism 70 includes a two stage manual release mechanism which will now be described in detail with reference to FIGS. 5 to 8. The manually operable unlocking member 75 is a substantially planar member which is positioned in abutment with an upper facing surface 81 of the manually operable release member 80. The unlocking member 75 is slidable over the facing surface 81 of the release member 80 in a lateral direction indicated by the arrow D which runs in substantially the same direction as the arrow C. The unlocking member 75 is slidable from a resting locking position to an unlocking position. A lower surface 76 of the unlocking member 75 includes a set of downwardly extending abutting projections 77a, 77b, 77c, 77d which are arranged to be received through a respective slot 83a, 83b, 83c, 83d in the release member 80. The slots 83a-83d extend between the facing surface 81 and the lower surface 82 of the release member 80. In the locking position the abutting projections 77a-77d each abut against a shoulder portion 84a, 84b, 84c, 84d of a respective one of the upstanding mounting projections 88a, 88b of the frame 85. When the unlocking member 75 is slid in the lateral direction indicated by the arrow D along the facing surface 81 of the release member 80 the abutting projections 77a-77d slide within their respective slot 83a-83d to the unlocking position in which the projections 77a-77d are no longer in abutment with the shoulder portions 84a-84d of the upstanding mounting projections 88a, 88b of the frame 85.

When the unlocking member 75 is in the locking position a user cannot depress the unlocking member 75 or the release member 80 in the direction of the arrow E because the abutting projections 77a-77d abut against the shoulders 84a-84d of the upstanding mounting projections 88a, 88b of the frame 85. When the unlocking member is in the unlocking position a user can depress both the unlocking member 75 and the release member 80 in the downward direction indicated by the arrow E because the abutting projections 77a-77d no longer abut against the shoulder portions 84a-84d of the mounting projections 88a, 88b. Thus, when the unlocking member 75 is in the unlocking position and a user depresses the unlocking member 75 and the release member 80 in the direction of the arrow E the lower surface 82 of the release member 80 engages the first arm 93a, 93b of the lever members 90a, 90b and pivots the lever members 90a, 90b in their respective arcs of motion Q₁, Q₂ in the manner described above. Accordingly, depressing the unlocking member 75 causes the engaging portions 56a-56e of the restraining members 50-54 to move out of engagement with, and thereby disengage, the opening 35 of a respective blade 26 to enable withdrawal of the blade 26 from within the respective opening 25-29 of the knife block 10.

Each of the abutting projections 77a-77d includes a tab 77aa, 77bb, 77cc, 77dd which engages the lower surface 82 of the release member 80 adjacent to the slots 83a-83d such that the release member 80 cannot be depressed independently of the unlocking member 75. As such, the release member 80 can only be depressed when the unlocking member 75 is in the unlocking position and cannot be depressed when the unlocking member 75 is in the locking position. The unlocking member 75 includes a lug 78 which is engaged by a biasing member 79, which in the embodiments illustrated is in the form of a torsion spring but may take any other suitable form. The biasing member 79 biases the unlocking member 75 towards the locking position so as to prevent inadvertent movement of the unlocking member 75 to the unlocking position. The fact that the unlocking member 75 is biased to the locking position provides that the resting position of the unlocking member 75 is the locking position. This also ensures that the two stage manual release mechanism of the blade release mechanism 70 is operable to ensure that each blade 26 can only be removed from within a respective one of the openings 25-29 upon deliberate manual sliding movement of the locking member 75 from the locking position to the unlocking position in the direction of the arrow D against the force of the biasing member 79 and subsequently depressing the locking member 75 and the release member 80 in the direction of the arrow E while holding the locking member 75 in the unlocking position.

After a user releases the locking member 75 and the release member 80, the biasing member 57a-57e associated with each of the restraining members 50-54 causes the sliding pivot member 64 to slide in the opposite direction to the arrow B to a resting position of the sliding pivot member. Movement of the sliding pivot member 64 to the resting position thereof causes the lever member 90 to pivot about the axis Z-Z such that the first arm 93 engages and pushes upwards against the lower surface 82 of the release member 80 to thereby bias the release member 80 in the upwards direction opposite to the direction indicated by the arrow E. Subsequently, the action of the biasing member 79 on the unlocking member 75 causes the unlocking member 75 to slide from the unlocking position to the resting locking position in the opposite direction to the direction represented by the arrow D. Accordingly, the resting position of the blade release mechanism 70 involves the release member 80 being in its resting position and the locking member 75 being in its resting position. In the resting position of the blade release mechanism 70, the restraining members 50-54 are in the active position to prevent inadvertent withdrawal of one or more of the blades 26 from within a respective one of the openings 25 to 29 of the knife block 10.

Thus, the blade restraining mechanism 60 is operable to prevent inadvertent withdrawal of one or more of the blades 26 from within a respective one of the openings 25 to 29 of the knife block 10 such as if the knife block 10 were tilted or overturned. The two stage manual release mechanism of the blade release mechanism 70 prevents inadvertently changing the state of the blade restraining members 50-54 from the active position to the inactive position either accidentally or by a child.

In the embodiment of the knife block 10 illustrated in FIGS. 1-4, the knife block 10 also includes a blade sharpener 100. The blade sharpener 100 includes a sharpener housing 105 and a sharpening device 110. The housing 105 has an opening 106 at one end that is configured to receive the sharpening device 110 therewithin. The sharpening device 110 may take any suitable form as long as the function of the sharpening device 110 is to sharpen the cutting edge 33 of the blade 26 of one or more of the knives 21-24. Mounted within the sharpening device 110 is a blade sharpener 150 and, optionally, a blade honing device 160. Thus, as a blade 26 is inserted into the sharpening device 110 the blade sharpener 150 and the honing device 160 respectively sharpen and hone the cutting edge 33 of the blade 26 either upon insertion of the blade 26 into the sharpening device 110 or withdrawal from the sharpening device 110 or both. In another possible form, not shown in the Figures, each one of the openings 25-29 for receiving a respective blade 26 therewithin could include a respective one of the blade sharpening devices 110 mounted within and adjacent to a respective one of the openings 25-29.

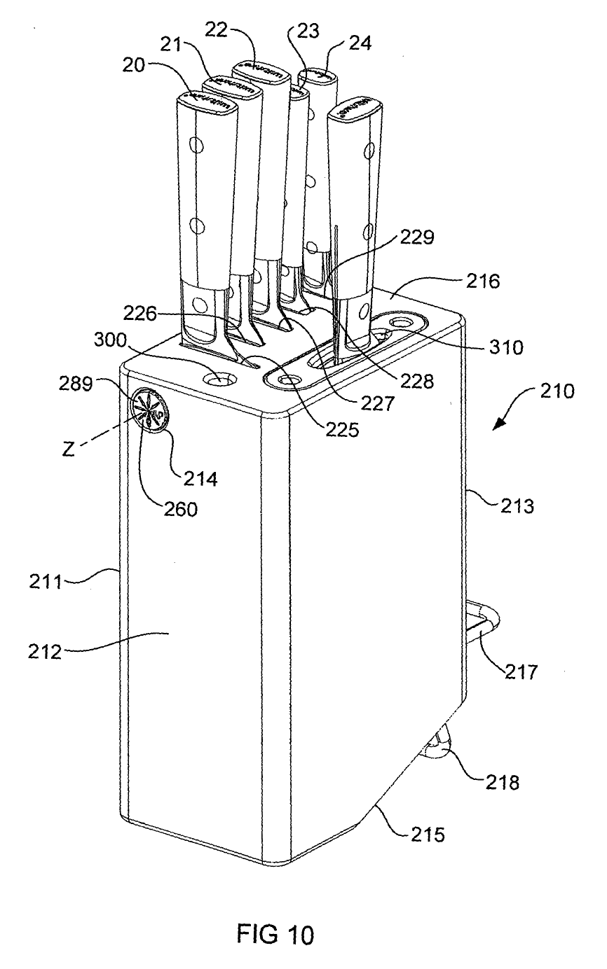

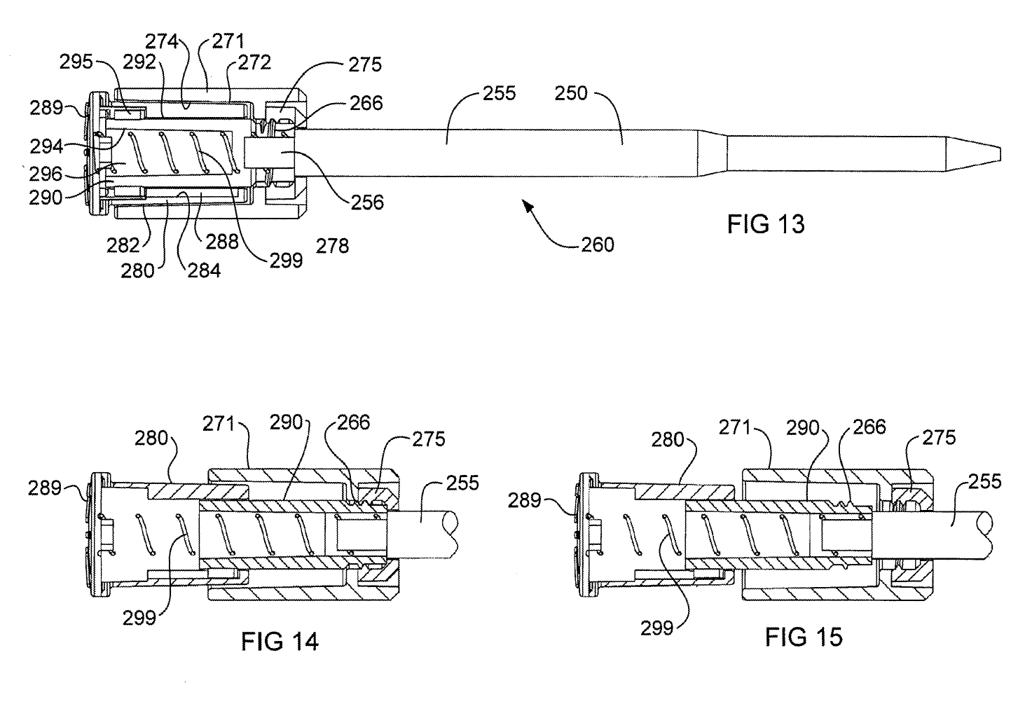

Referring to FIGS. 10 to 18, there is shown a device in accordance with another embodiment of the invention wherein features that are alike to the first embodiment of the invention described above are represented by like reference numerals. The device is in the form of a knife block 110, which is configured to store a plurality of knives 20, 21, 22, 23, 24 therein. Alternatively, the device may be a blade holder for storing a plurality of blades such as scissor blades, chisel blades or any other article including a blade or some other dangerous or hazardous component. The knife block 210 embodiment includes a housing 211 having a plurality of openings 225, 226, 227, 228, 229 in an upper surface 216 of the housing 211 of the knife block 210. Each of the openings 225, 226, 227, 228, 229 is in the form of a longitudinal slot for receiving a respective one of the knives 20-24 therein.

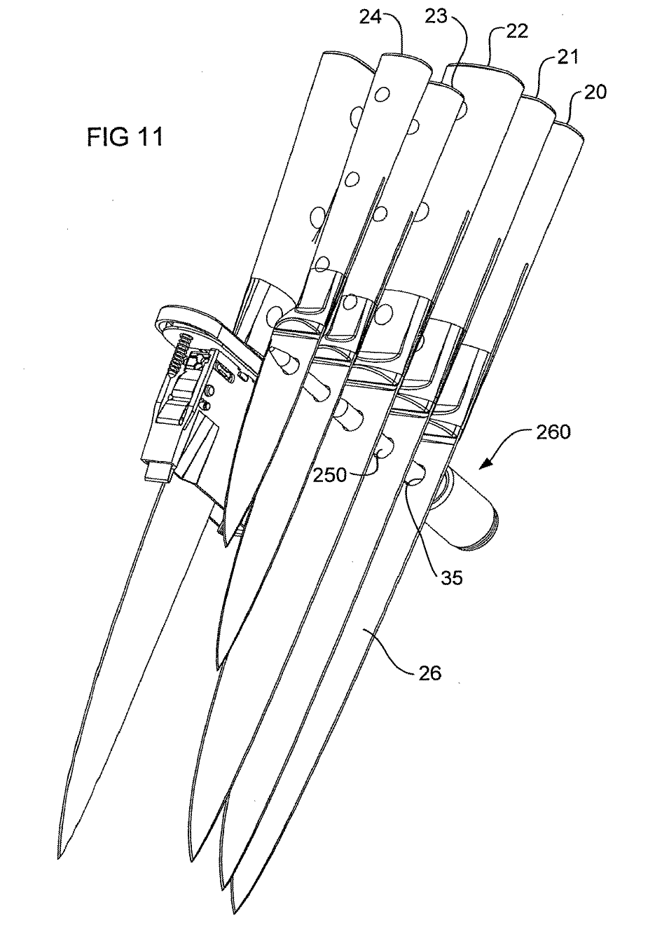

As shown in FIGS. 10-17, the knife block 210 includes a blade restraining mechanism 260 which includes a restraining member 250. The restraining member 250, when in the active condition as illustrated in FIGS. 10 and 11, is associated with each one of the openings 225-229 of the knife block 210. The restraining member 250 is an elongated member in the form of a rod 255 that is insertable in an aperture 214 located in a side of the housing 211 of the knife block 210. The aperture 214 of the knife block 210 opens up to an elongated passage (not shown) extending in a direction from one side 212 to an opposite side 213 of the knife block 210. As shown in FIG. 10, the elongated passage has longitudinally extending central axis Z. The rod 255 of the restraining member 250 is insertable through the aperture 214 and through the passage along the longitudinal axis of the passage until substantially the entire rod 255 of the restraining member 250 is within the passage.

As illustrated in FIG. 10, when the restraining member 250 is inserted in the aperture 214 such that substantially the entire rod 255 is positioned within the knife block 210, as illustrated in FIG. 11, the rod 255 is located within the within each one of the openings 35 of each of the knives 20-24 positioned within respective openings 225-229 of the knife block 210. When the rod 255 is so located within the openings 35 of each one of the knives 20-24 the restraining member 250, and in turn the restraining mechanism 260, is operable for preventing withdrawal of each one of the knives 20-24 from their position within respective openings 225-229 of the knife block 210.

The restraining mechanism 260 also includes a locking mechanism 265 that includes a male threaded portion 266 that is coupled to the rod 255 and a female threaded portion 275 that is coupled to the housing 211 within the aperture 214 of the knife block 210. When the restraining member 250 is inserted in the aperture 214 such that substantially the entire rod 255 is positioned within the knife block 210, as illustrated in FIG. 11, the male threaded portion 266 is screwed into the female threaded portion 275 so as to lock the entire rod 255 within the passage within the knife block 210. Removing the rod 255 from within the knife block 210 involves unlocking the rod 255 from within the passage within the knife block 210. Unlocking the rod 255 from within the passage within the knife block 210 involves unscrewing the male threaded portion 266 from within the female threaded portion 275. When the male threaded portion 266 has been unscrewed from within the female threaded portion 275 the restraining member 250 can be withdrawn from the passage and the aperture 214 within the housing 211. With the restraining member 250 withdrawn from the aperture 214 within the housing 211 each one of the knives 20-24 can be withdrawn from their position within respective openings 225-229 of the knife block 210. The restraining member 250 is in the inactive condition when withdrawn from the aperture 214 within the housing 211.

The male threaded portion 266 and the female threaded portion 275 form part of a blade release mechanism 270 of the restraining mechanism 260. However, prior to a user being able to manually unscrew the male threaded portion 266 from the female threaded portion 275 a user must carry out at least one prior stage of movement or, as in the present embodiment, at least two prior stages of movement. Thus, in the present embodiment, manually unscrewing the male threaded portion 266 from the female threaded portion 275 constitutes a third stage of movement involved in the blade release mechanism 270. It is to be appreciated that there may be other stages of movement required to enable each one of the knives 20-24 to be withdrawn from their position within respective openings 225-229 of the knife block 210. For example, withdrawal of the restraining member 250 from the aperture 214 within the housing 211 could constitute a fourth stage of movement.

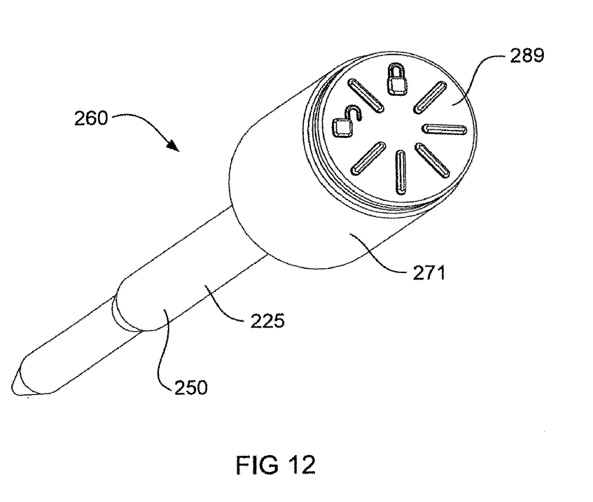

Referring to FIGS. 12 to 17, features of the blade release mechanism 270 will now be described in more detail. The blade release mechanism 270 includes an outer housing 271 that is fixed within the aperture 214 of the knife block 210. The outer housing is a substantially cylindrical member having an internal cylindrical passage 272. The cylindrical passage 272 is defined by a cylindrical wall 274 extending between opposite open ends of the passage 272. An annular flange 273 projects from the wall 274 into the passage 272. The male threaded portion 266 is captured within the cylindrical passage 272 on one side of the flange 273. On the other side of the flange 273 an intermediate housing 280 is positioned within the cylindrical opening 272 within the outer housing 270. The intermediate housing 280 has a cylindrical outwardly facing surface 282 that is sized to fit within, and rotate relative to, the wall 274 defining the passage 272 within the outer housing 271. The intermediate housing 280 has an inwardly facing surface 284 that is also substantially cylindrical in shape to define a substantially cylindrical passage 288. One end of the passage 288 is open and the opposite end is enclosed by a button 289. The open end of the passage 288 receives an inner housing 290 therewithin. The inner housing 290 is a cylindrical member that has an inwardly facing surface 294 that defines a cylindrical passage 295 therethrough. The passage 295 is open at both ends, however, one end, at which the male threaded portion 266 is integrally connected to the inner housing 290, is enclosed by a projection 256 extending from the rod 255 which is inserted into the passage 295. The projection 256 is fixed within the passage 295 within the inner housing 290 such that the inner housing 290 and the rod 255 are essentially integral. A biasing means, in the form of a helical spring 299 is positioned within the passage 295 within the inner housing 290. One end of the spring 299 abuts with the rod 255 whereas the other end abuts with the button 289.

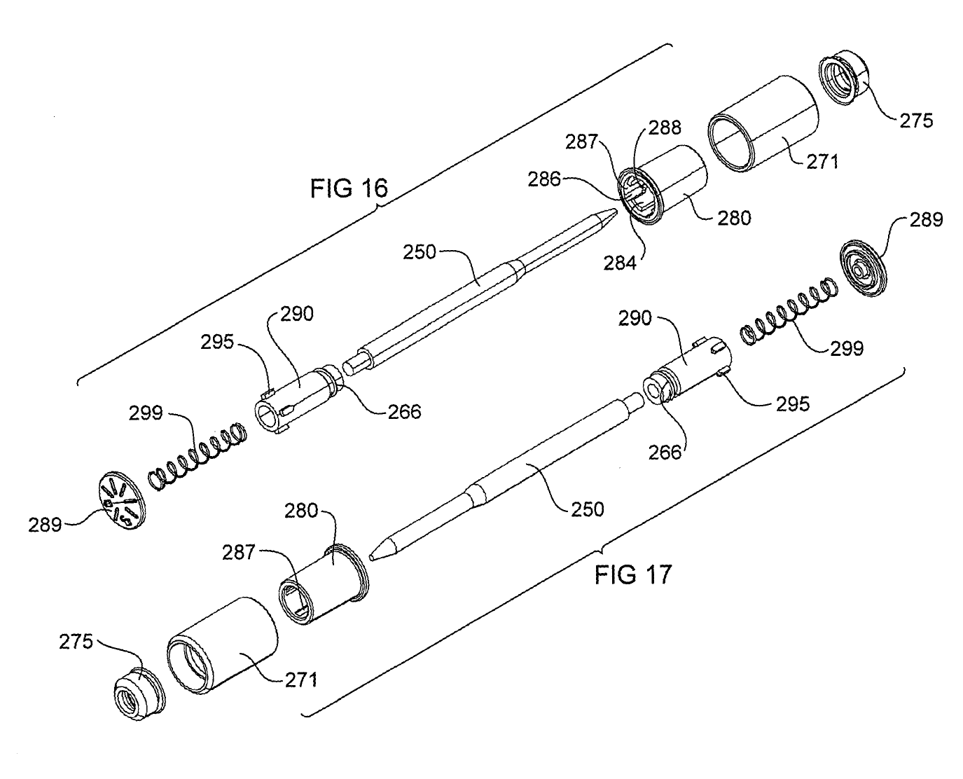

Referring to FIGS. 16 and 17, the inner housing 290 has an outwardly facing cylindrical surface 292. A set of protrusions 295 project radially outwardly from the outward surface 292 of the inner housing 290. Each one of the protrusions 295 fits within a shaped groove 285 in the inwardly facing surface 284 of the intermediate housing 280 when the inner housing 290 is positioned within the intermediate housing 280. The shaped grooves 285 each have a pair of adjacent and connected long 287 grove sections and short groove sections 286. The long groove section 287 extends substantially the entire length of the inwardly facing surface 284 of the intermediate housing 280 in an axial direction. The short groove section 286 extends from the button 289 along a shorter length of the inwardly facing surface 284 of the intermediate housing 280 in the axial direction. The short groove section 286 is formed with a ramp 288 along a boundary with the long groove section 287. The spring 299 is operable to bias the button 289 and the intermediate housing 280 in an axial direction away from the rod 255 and the inner housing 290 such that when each of the protrusions 295 is positioned within one of the short groove sections 286 the ramp 288 prevents rotation of the inner housing 290 relative to the intermediate housing 280 such that the protrusions 295 remain within the short groove sections 286.

When the restraining mechanism 260 is positioned within the aperture 214 and the passage of the knife block 210 and the male and female threaded portions 266, 275 are screwed together the button 289 is substantially flush with the side 212 of the housing 211 of the knife block 210. Thus a user cannot grip the intermediate housing 180 to unscrew the male threaded portion 266 from the female threaded portion 275. When a user presses the button 289 into the aperture 214 this force overcomes the biasing force of the spring 299 and moves the ramp 288 of each short groove section 286 beyond each of the protrusions 295. The user may then rotate the button 289 and the intermediate housing 280 relative to the inner housing 290 such that the protrusions 295 move over the ramps 288 and into the long groove sections 287. The user may then release the button 289 such that the biasing force of the spring 299 may cause the intermediate housing 280 to move in the axial direction relative to the inner housing 290 in a direction away from the rod 255 as illustrated in FIGS. 14 and 15. As a result, the intermediate housing 280 projects out of the aperture such that a user may grip the outer surface 282 and rotate the intermediate housing 280 about the axis Z relative to the inner housing 290. By rotating the intermediate housing 180 about the axis Z relative to the inner housing 290 the male threaded portion 166 can be unscrewed from the female threaded portion 275 and the rod 255 removed from within the passage and the aperture 214 within the knife block 210.

The above described features of the blade restraining mechanism 260 provide a blade release mechanism 270 including at least three stages of movement. The first stage of movement involves the user depressing the button 289 so that the button 289 moves or translates in a linear direction along an axial direction into the aperture 214 of the knife block. The second stage of movement involves rotating the button 289 about the axis in a direction that is substantially transverse to the first direction of movement such that the intermediate housing 280 can be biased out of the aperture by the spring 299. The third stage of movement involves manually rotating the intermediate housing 280 relative to the aperture 214 and the outer housing 271 captured therewithin such that the male threaded portion 266 is unscrewed from the female threaded portion 275 that is captured within the outer housing 271. The restraining member 250, including the rod 269, the inner housing 290 and the intermediate housing 280 are free to be moved in the axial direction out of the aperture 214 and the passage within the housing 211 of the knife block 210. Movement of the restraining member 250 out of the aperture 214 and the passage within the housing 211 of the knife block 210 may constitute a fourth stage of movement of the blade release mechanism 270. When the restraining member 250 is removed from the knife block 210 in the manner described above it may be stored in an opening 300 in the upper surface 216 of the housing 211 of the knife block 210.

As will be appreciated, the intermediate housing 280 cannot be rotated relative to the aperture 214 and the outer housing 271 unless a user first carries out the first two stage of movement of the blade release mechanism 270. That is until the user first depresses the button 289 and then rotates the button 289. Accordingly, the two stages of movement required by the blade release mechanism 270 is operable to prevent inadvertent withdrawal of one or more of the blades 26 from within a respective one of the openings 225 to 229 of the knife block 210 such as if the knife block 210 were tilted or overturned. The two stage manual release mechanism of the blade release mechanism 270 also prevents inadvertently changing the state of the blade restraining member 250 from the active position to the inactive position either accidentally or by a child without sufficient dexterity to actuate the blade release mechanism 270 through the at least two stages of movement thereof.

When a user wishes to return one or more of the blades 26 to the knife block 210 the reverse of the above described process must be carried out. In particular, if the blade restraining member 250 has not been removed from the knife block 210 in the manner described above then the user must remove the blade restraining member 250 from the knife block 210. The user must then insert the blade 26 into a respective one of the openings 225-229. The user must then insert the restraining member 250, in particular the rod 255, into the aperture 214 in the knife block 210 such that the rod 255 is located within the opening 35 within the inserted blade 26 and within the opening 35 of any other blades 26 inserted in any of the other openings 225-229 within the knife block 210. The user must then manually rotate the intermediate housing 280 relative to the aperture 214 and the outer housing 271 captured therewithin such that the male threaded portion 266 is screwed into the female threaded portion 275 that is captured within the outer housing 271. The user must then depress the button 289 and overcome the biasing force of the spring 299 so that the button 289 moves or translates in a linear direction along the axial direction into the aperture 214 of the knife block such that the protrusions 295 move in the axial direction through the long groove sections 287. The user must depress the button 289 until the protrusions 295 are moved beyond the ramp 288 of each short groove section 286. The user may then rotate the button 289 and the intermediate housing 280 relative to the inner housing 290 such that the protrusions 295 move over the ramps 288 and into the short groove sections 286. When the user releases the button 289 the intermediate housing 280 is retained within the outer housing 270 and the button 289 remains flush with the side 212 of the knife block 210.

In the embodiment of the knife block 210 illustrated in FIGS. 10-18, the knife block 210 also includes a blade sharpening device 310. The blade sharpening device 310 is substantially identical to the blade sharpening device 210 of the embodiment disclosed in FIGS. 1 to 9 and described above.

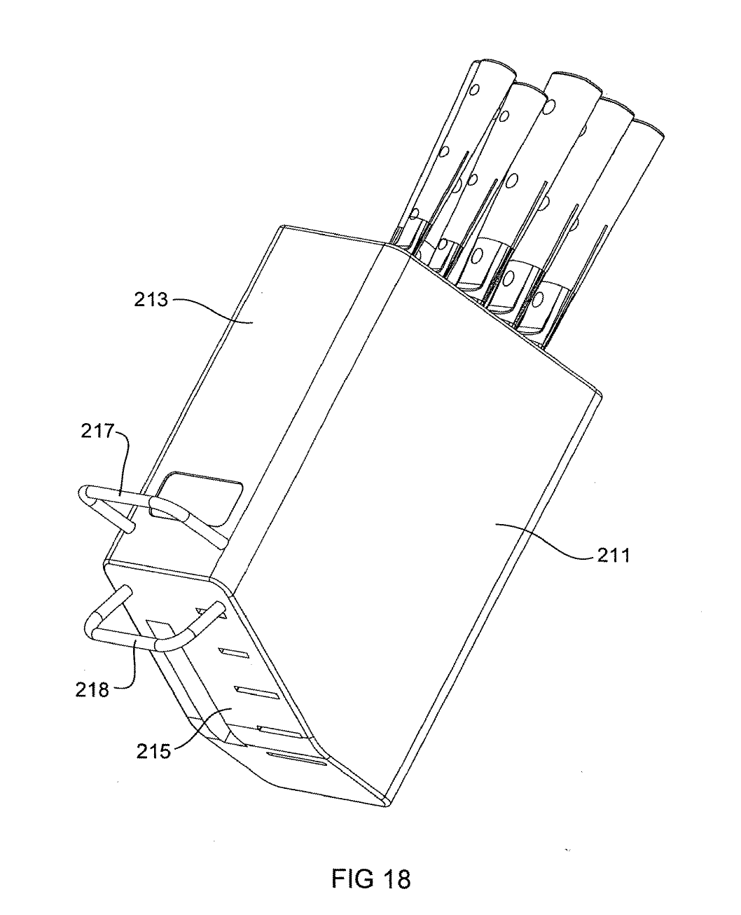

Referring to FIGS. 10 and 18, the housing 211 of the knife block 210 also can include a means for enabling the knife block 210 to rest on a surface in at least two orientations. The housing 211 has a first supporting member 217 in the form of a shaped bar member that is mounted to a side 213 of the housing 211 and a second supporting member 218 in the form of a shaped bar mounted to a base 215 of the housing 211. The base 215 of the housing includes a flat portion and a sloped portion. When the second supporting member 218 is removed from the housing 211 the first supporting member 217 enables the housing 211 of the knife block 210 to rest on a surface in a stable manner on the sloped portion of the base 215 such that the knives 20-24 are tilted relative to the supporting surface. The second support member 218 enables the housing 211 of the knife block 210 to rest on a surface in a stable manner on the flat portion of the base 215.

Various alterations, modifications and/or additions may be introduced into the constructions and arrangements of parts previously described without departing from the spirit or ambit of the invention as defined by the appended claims.

1. A device for containing one or more blades, the device including:
a housing having a plurality of openings, each opening of the housing for containing a respective blade therein;
a blade restraining mechanism including a restraining member having active and inactive conditions in that when a blade is inserted within one of the openings of the housing such that substantially an entire cutting edge of the blade is within the opening of the housing, in the active condition the restraining member prevents withdrawal of the blade from the opening of the housing and in the inactive condition the restraining member allows withdrawal of the blade from the opening of the housing;
wherein the restraining member is operable for engaging an opening within the blade when in the active position to prevent withdrawal of the blade from the opening of the housing and for disengaging the opening within the blade when in the inactive position to allow withdrawal of the blade from the opening of the housing.

2. The device for containing one or more blades as defined in claim 1, wherein the blade restraining mechanism includes one or more restraining members, wherein each restraining member is associated with one or more of the openings of the housing.

3. The device for containing one or more blades as defined in claim 1, wherein the blade restraining mechanism includes a blade release mechanism that is operable for causing the one or more restraining members to change from the active condition to the inactive condition.

4. The device for containing one or more blades as defined in claim 3, wherein the blade release mechanism is operable for causing each of the one or more restraining members to change from the active condition to the inactive condition.

5. The device for containing one or more blades as defined in claim 3, wherein the blade release mechanism includes a manual release mechanism including at least two stages of movement.

6. The device for containing one or more blades as defined in claim 5, wherein a first one of the stages involves manually moving a manually operable release member in a first direction and the second stage involves manually moving the manually operable release member in a second direction.

7. The device for containing one or more blades as defined in claim 6, wherein the first direction is transverse to the second direction.

8. The device for containing one or more blades as defined in claim 6, wherein the first direction of movement involves linear translation of the manually operable release member along an axis and the second direction of movement involves rotation of the manually operable release member about the axis.

9. The device for containing one or more blades as defined in claim 6, wherein the blade release mechanism includes a third stage of movement.

10. The device for containing one or more blades as defined in claim 1, the blade restraining mechanism includes one restraining member in the form of an elongated blade engaging member that is positionable adjacent the openings of the housing and extending substantially perpendicular to opposite parallel sides of the blade when the blade is inserted within the opening of the housing, the elongated blade engaging member being movable between a position in which when substantially the entire cutting edge of the blade is within the opening of the housing the elongated blade engaging member engages the blade and prevents withdrawal of the blade and a position in which when substantially the entire cutting edge of the blade is within the opening of the housing the elongated blade engaging member is out of engagement with the blade and allows withdrawal of the blade.

11. The device for containing one or more blades as defined in claim 10, the elongated blade engaging member includes a rod that is receivable within the opening within the blade.

12. The device for containing one or more blades as defined in claim 11, the housing includes an aperture that is aligned with the direction of the opening within the blade when the blade is inserted within the opening of the housing, the aperture receives the rod therethrough when the blade restraining member is in the active condition.

13. The device of claim 1, wherein the device is a knife block.

14. The device of claim 1, further including a blade sharpener for sharpening the cutting edge of the blade.

15. In combination a blade and a device for containing one or more of the blades including the device of claim 1.

16. The combination of claim 15, wherein the blade includes opposite substantially parallel sides which meet at a cutting edge, the opening within the blade extends between and transversely to the substantially parallel sides of the blade and is enclosed within the blade, wherein the opening within the blade is engaged by the restraining member when in the active position to prevent withdrawal of the blade from the opening of the housing and which is disengaged by the restraining member when in the inactive position to allow withdrawal of the blade from the opening of the housing.

17. The combination of claim 15, wherein the opening within the blade is in the form of a substantially round hole extending through the blade between the opposite parallel sides of the blade.

18. A blade configured for use with the device for containing one or more blades of claim 1, the blade including a handle and opposite substantially parallel sides extending from the handle which meet at a cutting edge, an opening within the blade extending transversely to the parallel sides and positioned adjacent to the handle.

19. The blade of claim 18, wherein the opening within the blade is in the form of a substantially round hole extending through the blade between the opposite parallel sides of the blade.
